(19) United States
(12) Patent Application Publication
(10) Pub. No.: US 2008/0280072 A1
(43) Pub. Date: Nov. 13, 2008

(54) CELLULOSE ESTER FILM AND PRODUCTION METHOD THEREOF

(75) Inventors: Toshinao ARAI, Minami-ashigara-shi (JP); Hidekazu YAMAZAKI, Minami-ashigara-shi (JP)

Correspondence Address: SUGHRUE MION, PLLC, 2100 PENNSYLVANIA AVENUE, N.W., SUITE 800, WASHINGTON, DC, 20037, US

(73) Assignee: FUJIFILM CORPORATION, Tokyo (JP)

(21) Appl. No.: 12/051,549

(22) Filed: Mar. 19, 2008

(30) Foreign Application Priority Data
Mar. 20, 2007 (JP) 2007-071915

(51) Int. Cl. C09K 19/32; B29D 7/01

(52) U.S. Cl. 428/1.33; 264/217

(57) ABSTRACT

A dope containing a retardation controller, cellulose ester, and a solvent is prepared. In a first film producing apparatus, the dope is cast onto a casting drum whose surface is cooled to form a casting film in a gel state. The casting film is peeled off from the casting drum, and the peeled casting film is dried until a residual solvent amount reaches 10 wt. %. Cellulose ester contained in the casting film is crystallized by heating the casting film to a temperature of not less than 170° C. and not more than 250° C., and the casting film is stretched in the width direction. Thus, a film is produced. An absolute value |P1| of a degree of orientation of the polymer in the in-plane direction of the produced film satisfies 0≦|P1|≦0.050.

### FIELD OF THE INVENTION

The present invention relates to a cellulose ester film represented by a retardation film which compensates a phase difference of a polarizing filter, and a production method of the cellulose ester film.

### BACKGROUND OF THE INVENTION

In accordance with recent demands for miniaturization and thinning of electronic devices such as personal computers and cellular phones, demands for liquid crystal displays (LCDs) are growing sharply. The LCDs are used as image display devices which replace conventional CRT (cathode ray tube) displays. The LCD is constituted of optical parts such as a light source, a substrate, a polarizing filter, a liquid crystal layer, and displays high-quality images.

A polarizing filter is considered to be an important part in the LCD, since it transmits only the light component oscillating in a specific direction (linear direction) of light oscillating in all directions. However, if the polarizing filter is singly used, distortion of light (birefringence) occurs during transmission of polarized light component through a liquid crystal, which degrades image quality. To prevent this problem, a retardation film with a proper phase difference is normally attached to the polarizing filter to minimize the distortion of light. Polymer films are mainly used as the retardation films owing to a high degree of transparency, and ease of processing. Particularly, cellulose ester films made of cellulose ester are widely used owing to its higher degree of transparency.

A cellulose ester film is mainly produced by a solution casting method. In the solution casting method, a casting film is formed by casting a dope containing cellulose ester, an additive, and a solvent onto a moving support, and then the casting film is peeled off from the support and dried to form a film. Thus, the solution casting method reduces damage caused by heat to raw materials of the film such as cellulose ester and additives during the film production. Accordingly, the solution casting method is capable of producing films with the high degree of transparency and excellent optical properties. Owing to this, the solution casting method is mainly used in producing optical films such protection films for polarizing filters, antireflection films, and wide view films in addition to the retardation films.

A compensation amount of optical distortion in the retardation film depends on a retardation value of the film. The compensation effect increases as the retardation value increases. Therefore, it is preferable to increase the degree of transparency and the retardation value as much as possible in producing the retardation film. In order to increase the retardation value, in general, a retardation controller, which increases the retardation value, is added to the casting film. In addition, such casting film is uniaxially stretched in the width direction to increase the degree of molecular orientation in the polymer and the retardation controller. Thus, the high retardation value is achieved.

However, the films with the high degree of orientation are sensitive to humidity changes. As a result, an in-plane retardation “Re” of the film and a retardation “Rth” in the thickness direction of the film change due to humidity changes, and the contrast is lowered. Therefore, a method to produce a cellulose ester film in which humidity dependence is reduced as much as possible is demanded. The humidity dependence means a degree of changes in the optical properties of the cellulose ester film caused by humidity. The in-plane retardation “Re” is a retardation value in the in-plane direction of the film. The in-plane direction is a direction vertical to the thickness direction of the film.

In order to solve the above problems, for example, Japanese Patent Laid-Open Publication No. 2005-138375 suggests a method in which a dope containing cellulose acylate, a predetermined additive, and a solvent is cast onto a support to form a casting film, and then the formed casting film is peeled off from the support, and the peeled film is dried at a temperature of not less than glass transition temperature of cellulose acylate. On the other hand, Japanese Patent Laid-Open Publication No. 2005-139304 suggests cellulose acylate film containing a compound having acyl group which normally does not form hydrogen bond with water. The cellulose acylate film satisfies the following Rth values: an absolute value of the Rth is not more than 25 nm under 25° C./60% RH, and a difference between the Rth values under 25° C./10% RH and 25° C./80% RH is not more than 40 nm.

However, it is difficult to control the degree of orientation in the film plane by controlling drying temperature as disclosed in Japanese Patent Laid-Open Publication No. 2005-138375 or reducing water absorption in the film as disclosed in Japanese Patent Laid-Open Publication No. 2005-139304. Therefore, it is difficult to achieve a high retardation value using the above-described methods. At present, it has not yet become possible to sufficiently reduce the humidity dependence of the retardation films to satisfy optical properties required for the large display devices. In particular, it has been impossible to produce the film having the retardation Re of equal to or more than 40 nm and low humidity dependence of the Re.

### SUMMARY OF THE INVENTION

In view of the above, an object of the present invention is to provide cellulose ester film having a high retardation value with low humidity dependence, and a production method thereof.

To achieve the above and other objects, a cellulose ester film of the present invention contains a retardation controller, cellulose ester with a degree of orientation P1 in an in-plane direction of the cellulose ester film satisfying 0≦|P1|≦0.050, and a retardation Re of not less than 40 nm and not more than 80 nm in an in-plane direction of the cellulose ester film. The retardation Re is defined by the following mathematical expression (1): Re=(nx−ny)×d, wherein “nx” is a refractive index in a slow axis direction in the in-plane of the cellulose ester film, “ny” is a refractive index in a fast axis direction in the in-plane of the cellulose ester film, and “d” is a thickness (unit: nm) of the cellulose ester film.

It is preferable that a retardation Rth in a thickness direction of the cellulose ester film is not less than 100 nm and not more than 300 nm. The retardation Rth is defined by the following mathematical expression (2): Rth={(nx+ny)/2−nz}×d, wherein “nx” is a refractive index in a slow axis direction in the in-plane of the cellulose ester film, “ny” is a refractive index in a fast axis direction in the in-plane of the cellulose ester film, and “d” is a thickness (nm) of the cellulose ester film.

A production method of cellulose ester film includes a step of: preparing a dope containing a retardation controller, cellulose ester, and a solvent; a step of forming a casting film by casting the dope onto a cooled moving support; a step of peeling the casting film from the support and drying the peeled casting film. After the residual solvent amount of the casting film reaches 10 wt. %, the casting film is heated to not less than 170° C. and not more than 250° C. so as to crystallize the cellulose ester, and the casting film containing the crystallized cellulose ester is stretched at a stretch ratio of not less than 10% and not more than 60%.

According to the present invention, the cellulose ester film having a high retardation value with low humidity dependence is produced. To be specific, the retardation Re is not less than 40 nm and not more than 80 nm, the Rth is not less than 100 nm and not more than 300 nm. The produced film is excellent in compensating the phase difference. By virtue of this, the produced film is also effective as a retardation film for use in an LCD, regardless of the modes such as OCB mode, VA mode, or TN mode. Therefore, the LCD with high image quality is produced by adhering the films of the present invention to polarizing filters.

### BRIEF DESCRIPTION OF THE DRAWINGS

The above objects and advantages of the present invention will become more apparent from the following detailed description when read in connection with the accompanying drawings, in which:

FIG. 1A is a schematic view of a first film producing apparatus of the present invention; and

FIG. 1B is a schematic view of a second film producing apparatus of the present invention.

### DETAILED DESCRIPTION OF THE PREFERRED EMBODIMENTS

First, a dope according to the present invention is described. Cellulose ester contained in the dope is, for example, lower fatty acid ester of cellulose, such as cellulose triacetate, cellulose acetate propionate, and cellulose acylate butyrate. In order to form a film with excellent optical transparency, cellulose acylate is preferable, and triacetyl cellulose (TAC) is especially preferable. It is preferable to use TAC particles at least 90 wt. % of which have a diameter of 0.1 mm to 4 mm.

It is preferable that a degree of substitution of hydroxyl group for acyl group in cellulose acylate preferably satisfies all of the following mathematical expressions (a)-(c) so as to produce a film with a high degree of transparency.

2.5≦A+B≦3.0 (a)

0≦A≦3.0 (b)

0≦B≦2.9 (c)

In these mathematical expressions (a) to (c), A is the degree of substitution of the hydrogen atom of the hydroxyl group for the acetyl group, and B is a degree of substitution of the hydroxyl group for the acyl group with 3 to 22 carbon atoms.

The cellulose is constructed of glucose units making β-1,4 combination, and each glucose unit has a free hydroxyl group at second, third and sixth positions. Cellulose acylate is a polymer in which a part of or the entire of the hydroxyl groups are esterified so that the hydrogen is substituted by acyl group with two or more carbons. The degree of substitution for the acyl groups in cellulose acylate is a degree of esterification of the hydroxyl group at second, third or sixth position in cellulose. Accordingly, when all (100%) of the hydroxyl group at the same position are substituted, the degree of substitution at this position is 1.

When the degrees of substitution of the acyl groups for the hydroxyl group at the second, third or sixth positions are respectively described as DS2, DS3 and DS6, the total degree of substitution of the acyl groups for the hydroxyl group at the second, third and sixth positions (namely DS2+DS3+DS6) is preferably in the range of 2.00 to 3.00, more preferable in the range of 2.22 to 2.90. It is especially preferable that DS2+DS3+DS6 is in the range of 2.40 to 2.88. Further, DS6/(DS2+DS3+DS6) is preferably at least 0.28, and more preferably 0.30. It is especially preferable that DS6/(DS2+DS3+DS6) is in the range of 0.31 to 0.34.

One or more sorts of acyl group may be contained in the cellulose acylate of the present invention. When two or more sorts of the acyl groups are used, it is preferable that one of them is acetyl group. If the total degree of substitution of the acetyl groups for the hydroxyl group and that of acyl groups other than the acetyl group for the hydroxyl group at the second, third or sixth positions are respectively described as DSA and DSB, the value DSA+DSB is preferably in the range of 2.22 to 2.90, and especially preferably in the range of 2.40 to 2.88.

Further, the DSB is preferable to be at least 0.30, and especially preferable at least 0.7. Further, in DSB, the percentage of the substituent for the hydroxyl group at the sixth position is preferably at least 20%, more preferably at least 25%, especially preferable at least 30% and more especially preferable at least 33%. Further, a value DSA+DSB at the sixth position of cellulose acylate is preferably at least 0.75, more preferably at least 0.80, and especially preferable at least 0.85. By using cellulose acylate satisfying the above conditions, a solution (or dope) having excellent solubility can be prepared.

Cellulose which is a raw material of cellulose acylate may be produced from cotton linter or pulp. However, cellulose produced from cotton linter is preferable.

Acyl group, of cellulose acylate, having at least 2 carbon atoms may be aliphatic group or aryl group, and is not especially restricted. As examples of the cellulose acylate, there are alkylcarbonyl ester, alkenylcarbonyl ester, aromatic carbonyl ester, aromatic alkylcalbonyl ester and the like. Further, the cellulose acylate may be also esters having other substituents. The preferable substituents are propionyl group, butanoyl group, pentanoyl group, hexanoyl group, octanoyl group, decanoyl group, dodecanoyl group, tridecanoyl group, tetradecanoyl group, hexadecanoyl group, octadecanoyl group, iso-butanoyl group, t-butanoyl group, cyclohexane carbonyl group, oleoyl group, benzoyl group, naphtylcarbonyl group, cinnamoyl group and the like. Among them, propionyl group, butanoyl group, dodecanoyl group, octadecanoyl group, t-butanoyl group, oleoyl group, benzoyl group, naphtyl carbonyl group, cinnamoyl group and the like are particularly preferable, and propionyl group and butanoyl group are especially preferable.

The cellulose acylate usable in the present invention are detailed in paragraphs [0140] to [0195] in Japanese Patent Laid-Open Publication No. 2005-104148. These descriptions may be applied to the present invention.

At least one of a retardation controller and a plasticizer is added to the dope of the present invention so as to produce a film with a high retardation value. In this case, it is preferable to add the above described substance to the dope to occupy 11 wt. % to 25 wt. % of the whole solid content of the dope. In the case plural substances are used, the above amount denotes the total amount of the substances.

[Retardation Controller]

Retardation controllers used in the present invention are not particularly limited. Well-known additives capable of increasing retardation values of the films may be used. In particular, an additive with molecular weight of not less than 200 and not more than 1000 are preferable, and those with molecular weight of not less than 300 and not more than 850 are more preferable. Satisfying the above ranges, the additive has excellent solubility in a solvent, and is resistant to evaporation during the film production. Accordingly, the retardation controller becomes effective as intended. In addition, it is preferable that a boiling point of the retardation controller is not less than 260° C. One or a mixture of two or more kinds of the retardation controller may be used. The retardation controller may be added to the dope in a state of a solution in which the retardation controller is dissolved in a solvent such as alcohol or dichloromethane. Alternatively, the retardation controller may be directly added to the dope. Methods of adding the retardation controller to the dope are not particularly limited. The retardation controllers according to the present invention are detailed in paragraphs [0030] to of Japanese Patent Laid-Open Publication No. 2006-235483. These descriptions may be applied to the present invention.

[Plasticizer]

Well known plasticizers may be used, for example, phosphoric acid ester plasticizers such as triphenyl phosphate and biphenyl diphenyl phosphate, phthalic acid ester plasticizers such as diethyl phthalate, and polyester polyurethane elastomer and the like.

[Solvent]

It is preferable to use an organic compound capable of dissolving polymer which is used for the dope preparation as the solvent. In the present invention, a dope is a mixture produced by dissolving or dispersing polymer in a solvent. Therefore, solvents having low solubility for polymer may also be used. Examples of the solvents used for producing the dope are aromatic hydrocarbon (for example, benzene, toluene and the like), halogenated hydrocarbons (for example, dichloromethane, chloroform, chlorobenzene and the like), alcohols (for example, methanol, ethanol, n-propanol, n-butanol, diethylene glycol and the like), ketones (for example, acetone, methylethyl ketone, and the like), esters (for example, methylacetate, ethylacetate, propylacetate and the like), ethers (for example, tetrahydrofuran, methylcellosolve and the like) and the like. It is also possible to use a solvent mixture in which two or more of the above solvents are mixed.

In particular, hydrophobic solvents are preferable, and dichloromethane is most preferable. In addition, the above-described halogenated hydrocarbons having 1 to 7 carbon atoms are preferable. In view of compatibility with polymer, peelability, which is an index that quantifies the ease of peeling the casting film from a support, mechanical strength, and optical properties of the film, it is preferable to add one or a mixture of two or more kinds of alcohols having 1 to 5 carbon atoms to dichloromethane. The content of the alcohol(s) is preferably in the range of 2 wt. % to 25 wt. %, and especially preferable in the range of 5 wt. % to 20 wt. % of total solvent compounds in the solvent. Specific examples of the alcohols are methanol, ethanol, n-propanol, isopropanol, n-butanol, and the like, and in particular, it is preferable to use methanol, ethanol, n-butanol or a mixture thereof.

In order to reduce the influence on the environment to a minimum, a dope may be prepared without dichloromethane. In this case, ethers with 4 to 12 carbon atoms, ketones with 3 to 12 carbon atoms, and esters with 3 to 12 carbon atom are preferable as the solvent. It is also preferable to use a mixture of them. The ethers, ketones, and esters may have cyclic structure. Compounds having at least two functional groups thereof (namely, —O—, —CO—, and —COO—) may be used as the solvent. Note that the solvent compound may have other functional group such as alcoholic hydroxyl group. In the case the solvent compounds contain two or more kinds of functional groups, the number of carbons contained therein may be within a specified limit of the compound having any one of the functional groups, and is not be particularly limited.

Well-known additives such as ultraviolet (UV) absorbents, deterioration inhibitors, lubricating agents, and peeling improvers may be added to the dope as necessary. It is preferable to add fine particles to the dope so as to adjust a refractive index of the film and prevent adhesion of the films. It is preferable to use silicon dioxide derivatives as the fine particles. The term “silicon dioxide derivatives” of the present invention includes silicon dioxide and silicone resin having a three-dimensional network structure. The silicon dioxide derivatives with the alkylated surfaces are preferable. Hydrophobized particles such as alkylated particles are well dispersed in the solvent. As a result, the dope is prepared and the film is produced without coagulation of fine particles. Thereby, the film with a high degree of transparency and few surface defects is produced.

Commercially available Aerosil R805 (produced by Degussa Japan, Co., Ltd.), which is a silicon dioxide derivative introduced with octyl group on the surface, or the like may be used as the fine particles with the alkylated surfaces. In order to produce the film with a high degree of transparency while keeping the effect of the fine particles, the content of the fine particles with respect to the solid content of the dope is preferably not more than 0.2%. In addition, In order to prevent the fine particles from interference of passing of the light, the average particle diameter is preferably not more than 1.0 μm and more preferably 0.3 μm to 1.0 μm, and most preferably 0.4 μm to 0.8 μm.

As described above, it is preferable to use TAC to produce cellulose ester film excellent in optical transparency. In this case, a ratio of TAC is preferably 5 wt. % to 40 wt. % with respect to a total amount of the dope mixed with solvents and additives, and more preferably 15 wt. % to 30 wt. %, and most preferably 17 wt. % to 25 wt. %.

Solvents, plasticizers, ultraviolet absorbents, deterioration inhibitors, lubricating agents, peeling improvers, optical anisotropy controllers, retardation controllers, dyes, peeling agents, and the like usable in the present invention are detailed in paragraphs [0196] to [0516] of Japanese Patent Publication No. 2005-104148. These descriptions may be applied to the present invention. In addition, producing methods of a dope using TAC, for example, materials, raw materials, dissolution methods and adding methods of additives, filtering methods, and defoaming are disclosed in paragraphs [0517] to [0616] of Japanese Patent Laid-Open Publication No. 2005-104148. These descriptions may be applied to the present invention.

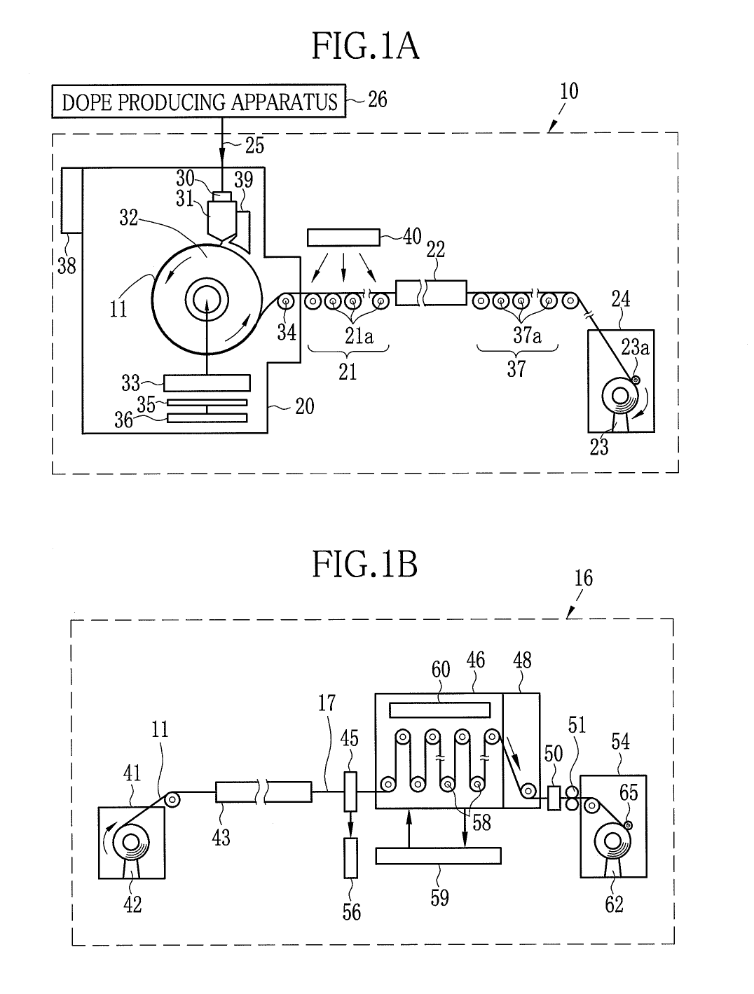

Next, a producing method of cellulose ester film according to the present invention is described. In this embodiment, a first film producing apparatus 10 shown in FIG. 1A, and a second film producing apparatus 16 shown in FIG. 1B are used.

In FIG. 1A, the first film producing apparatus 10 has a casting chamber 20, a transfer section 21, a first tenter 22, and a first winding chamber 24. In the casting chamber 20, a dope is cast onto a support to form a casting film 11. In the transfer section 21, the casting film 11 peeled off from the support is dried while being conveyed therethrough. The first tenter 22 enhances drying of the casting film 11. In the first winding chamber 24, the sufficiently dried casting film 11 is wound by a winding shaft 23 while being pressed by a press roller 23a. The first film producing apparatus 10 is connected to a dope producing apparatus 26 through a pipe 25, and an appropriate amount of the dope is fed from the dope producing apparatus 26.

In the casting chamber 20, a feed block 30, a casting die 31, a casting drum 32 which is the support, a coolant supplying device 33, a peel roller 34, a condenser 35, a recovery device 36, and a temperature controller 38 are provided. The casting die 31 has a discharge opening for casting the dope onto the casting drum 32. The coolant supplying device 33 supplies a coolant through a flow path formed inside the casting drum 32. The peel roller 34 supports the casting film 11 when peeled off from the casting drum 32. The condenser 35 condenses and liquefies solvent vapors in the casting chamber 20. The recovery device 36 recovers the liquefied solvent. The temperature controller 38 controls the inner temperature of the casting chamber 20.

Inside the feed block 30, channels for passing the dope are formed. A configuration of the channels is determined according to a layer structure of the casting film 11. For example, in the case of forming the casting film 11 constituted of plural layers, the feed block 30 having the number of channels corresponding to the number of the layers is used.

A discharge opening is formed at the end of the casting die 31. The discharge opening is opened toward the casting drum 32 to discharge the dope onto the casting drum 32. Shapes and dimensions of the casting die 31 are not particularly limited. However, in order to keep the width of the dope approximately uniform, the casting die 31 of a coat hanger type is preferably used. It is preferable that the width of the casting die 31 is in a range of 1.1 times and 2.0 times larger than the width of the film 17 as an end product so as to form the casting film 11 with a predetermined width without trouble. The material of the casting die 31 is preferably precipitation-hardened stainless steel in view of durability, heat resistance, and anti-corrosion. Specifically, it is preferable that the material has the anti-corrosion properties which do not form pitting (holes) on the gas-liquid interface after having been dipped in a liquid mixture of dichloromethane, methanol and water for three months. It is also preferable to use the material with the almost same anti-corrosion properties as SUS316 in examination of corrosion in electrolyte solution. In order to prevent damages by heat, it is preferable that the material has coefficient of thermal expansion of at most 2×10⁻⁵ (° C.⁻¹). In order to form the casting film 11 with excellent planarity, it is also preferable that the surface of the casting die 31 is grinded to reduce asperities.

It is preferable that a hardened layer is formed on end portions of the discharge opening of the casting die 31 to improve abrasion resistance. Forming methods of the hardened layer are not particularly limited. For example, ceramics coating, hard chrome plating, nitriding treatment and the like may be used. When ceramics are used as the hardened layer, it is preferable that the ceramics are grindable but not friable, and have a low porosity and the good corrosion resistance, and has a high adhesion property to the casting die 31, but do not stick to the dope. Examples of ceramics are tungsten carbide (WC), Al₂O₃, TiN, Cr₂O₃ and the like, and WC is especially preferable. The WC coating may be performed by a known spraying method.

The dope may be partially dried and become solid at the end portions of the discharge opening of the casting die 31. In order to prevent such solidification of the dope, it is preferable to install a solvent supplying device (not shown) at the end of the discharge opening, and supply a solvent which solubilizes the dope to three-phase contact lines of both side edge portions of the dope, both side ends of the discharge opening, and air. Thereby, the partial solidification of the dope is prevented and the uniform dope is formed. As a result, asperities in the casting film 11 are reduced. Since mixing of the solidified dope into the cast dope and the casting film 11 is also prevented, the film 17 with a high degree of transparency is produced. The solvent is not particularly limited as long as the solvent is a compound or a mixture of compounds capable of solubilizing the dope. For example, a mixture of 86.5 parts wt. of dichloromethane, 13 parts. wt. of methanol, and 0.5 parts wt. of n-butanol is used. It is preferable to supply the above described mixture to each of the above contact portions with a flow volume of 0.1 ml/min to 1.0 ml/min with the use of the pump with a pulsation of 5% or less.

A driving device (not shown) is attached to the casting drum 32. The driving device continuously rotates the casting drum 32 while controlling the number of rotations of the casting drum 32. It is preferable that the casting drum 32 is made of metal, which is excellent in heat-resistance and durability, in particular, stainless steel. Inside the casting drum 32, a flow path (not shown) for passing a cooling solvent (coolant) is formed. The coolant is used for cooling an outer peripheral surface (casting surface) of the casting drum 32. The surface temperature of the casting drum 32 is controlled within a predetermined range by supplying the coolant from the coolant supplying device 33 and passing it through the flow path. The coolant circulates between the casting drum 32 and the coolant supplying device 33.

In the present invention, it is also possible to use a belt for casting instead of the casting drum 32. In this case, an endless belt is looped over a pair of rollers and moved continuously. At least one of the pair of rollers is a drive roller. A configuration of a support such as the casting drum 32 is not particularly limited as long as its surface can be cooled to a temperature in a predetermined range. The present invention does not particularly limit the width, the materials, and the like of the support. However, it is preferable that the width of the support is in a range of 1.1 times to 2.0 times with respect to the casting width of the dope so as to form a uniform casting film 11. The support is preferably made of stainless steel in view of corrosion-resistance, and more preferably made of SUS316 so as to achieve sufficient corrosion-resistance and strength. In addition, the surface of the support is preferably polished as smooth as possible so as to form the casting film 11 with excellent planarity.

A decompression chamber 39 is installed at the rear of the casting die 31, and decompresses an area in the proximity of the casting die 31 while the dope is cast. The decompression chamber 39 has a jacket (not shown) which is capable of keeping the inner temperature of the decompression chamber 39 within a predetermined range. It is preferable to set the inner temperature of the casting chamber 20 at an approximately constant value during the casting of the dope. The inner temperature of the decompression chamber 39 is not particularly limited. However, the inner temperature is preferably not less than the condensation temperature of the solvent contained in the dope.

The transfer section 21 has a plurality of pass rollers 21a, and a drying device 40 for supplying dry air. The drying device 40 supplies dry air to dry the casting film 11 while the casting film 11 is held and conveyed by each of the pass rollers 21a.

Inside the first tenter 22, a pair of rails (not shown), a pair of endless chains (not shown), and a first drying device (not shown) are provided. The rail and the endless chain are disposed on each side of a conveying path of the casting film 11. The rails are placed at a predetermined distance. The endless chains rotate along the rails respectively. The first drying device supplies the dry air. Pin plates each having a plurality of pins are attached to the above chains. Both side edge portions of the casting film 11 are pierced and securely held by the pins. A conveying section 37 is installed between the first tenter 22 and the first winding chamber 24. The conveying section 37 is constituted of a plurality of rollers 37a and a drying device (not shown). The rollers 37a support the casting film 11, and the drying device enhances drying of the casting film 11 while the rollers 37a stably convey the casting film 11 to the first winding chamber 24.

The second film producing apparatus 16 shown in FIG. 1B is constituted of a feed chamber 41, a second tenter 43, an edge slitting device 45, a drying chamber 46, a cooling chamber 48, a neutralization device 50, a pair of knurling rollers 51, and a second winding chamber 54. The feed chamber 41 feeds the casting film 11 produced in the first film producing apparatus 10. The second tenter 43 stretches the casting film 11 in the width direction and dries it to form a film 17. The edge slitting device 45 cuts off the both side edge portions of the film 17. The drying chamber 46 sufficiently dries the film 17. The cooling chamber 48 cools the film 17. The neutralization device 50 adjusts charged voltage of the film 17 at an appropriate value. The pair of knurling rollers 51 provides knurling on the film 17. The second winding chamber 54 winds the film 17 in a roll form.

The feed chamber 41 is provided with a feeding device 42. The casting film 11 in the roll form is set in the feeding device 42. Inside the second tenter 43 is provided a pair of rails (not shown) and a second drying device (not shown). A distance between the rails is gradually increased from an inlet toward an outlet of the second tenter 43. The second drying device supplies dry air to the second tenter 43. An endless chain is looped around each rail. In the proximities of the inlet and the outlet of the second tenter 43 are provided chain sprockets (not shown). The above-described endless chains are looped around the sprockets at symmetrical positions about the conveying path of the casting film 11. The chain sprockets are connected to a driving section, which drives the rotation, to move the endless chains continuously. A plurality of clips are attached to each of the endless chains at predetermined intervals to hold the casting film 11.

A crusher 56 is connected to the edge slitting device 45. The crusher 56 crushes the cut-off side edge portions of the film 17 into chips. Inside the drying chamber 46 are provided a plurality of rollers 58, an adsorption-recovery device 59, and a temperature controller 60. The film 17 is bridged across the rollers 58 and conveyed by the rollers 58. The adsorption-recovery device 59 recovers solvent vapors in the drying chamber 46. The temperature controller 60 adjusts the inner temperature of the drying chamber 46. The second winding chamber 54 is provided with a winding shaft 62 for winding the film 17. A press roller 65 is attached to the winding shaft 62 to press the film 17 during winding.

It is not necessary to use different types of tenters for the first and the second tenters 22 and 43. However, when a residual solvent amount of the casting film 11 is large, the casting film 11 becomes unstable. As a result, it becomes difficult to hold the side edge portions of the casting film 11 with clips when the clip tenter is used. For this reason, it is preferable to use a pin tenter instead of the clip tenter. It is preferable to keep the drying temperature at an approximately constant value during the application of tension to the casting film 11, regardless of the stretching directions, so as to prevent differences in amounts of stretching caused by variations in the drying temperature.

Next, film production processes using the first and second film producing apparatuses 10 and 16 are described.

A dope produced in the dope producing apparatus 26 is fed to the feed block 30 in the first film producing apparatus 10 through the pipe 25. In this embodiment, the dope is made of TAC, a solvent mixture of three kinds of solvents, dichloromethane, methanol, and 1-butanol, and a retardation controller (N—N′-di-m-tolyl-N″-p-methoxyphenyl-1,3,5-triazine-2,4,6-triamine) and a plasticizer (triphenylphosphate and diphenyl phosphate).

Plural dopes are fed to the feed block 30 and joined together, and then fed to the casting die 31. A coolant at a predetermined temperature is supplied from the coolant supplying device 33 to the flow path inside the casting drum 32. The coolant is passed through the flow path to adjust the surface temperature of the casting drum 32. It is preferable to keep the surface temperature at not less than −40° C. and not more than 10° C. In addition, it is preferable to keep the inner temperature of the casting chamber 20 at an approximately constant value in a range of 20° C. to 40° C. using the temperature controller 38.

The dope is cast onto the continuously rotating casting drum 32 through the discharge opening provided at the end of the casting die 31. The temperature of the dope at the casting is preferably 20° C. to 55° C. The dope cast on the casting drum 32 is cooled thereon and the casting film 11 in a gel state is formed in a short time. It is preferable to make the temperature difference between the surface of the casting drum 32 and the dope large so as to cool the dope efficiently and effectively. Thus, the time for forming the casting film 11 is shortened. In this embodiment, the surface temperature of the casting drum 32 is −5° C., and the temperature of the dope is 32° C. It is preferable to adjust the flow volume of the dope at the time of forming the casting film 11 in accordance with the intended film thickness of the film 17. Preferable thickness of the film 17 is the order of 25 μm to 100 μm.

In order to form the casting film 11 with excellent planarity, speed fluctuations of the casting drum 32 is adjusted to be not more than 3%, and position fluctuations of the casting drum 32 in the vertical direction directly below the casting die 31 is adjusted to be not more than 500 μm. During the casting of the dope, an area upstream from the dope being cast, with respect to the moving direction of the casting drum 32, is preferably decompressed in a range of (atmospheric pressure −2000 Pa) to (atmospheric pressure −10 Pa). Thereby, a flow volume of entrained air causing asperities on the surface of the casting film 11 is reduced, and flapping of the dope is prevented by appropriately pulling the dope toward the upstream direction, with respect to the moving direction of the casting drum 32, during the casting. As a result, the casting film 11 with excellent planarity is formed.

The casting film 11 is conveyed in accordance with the rotation of the casting drum 32, and further cooled so that gelation of the casting film 11 is enhanced. Thereby, the casting film 11 obtains self-supporting property which makes peeling of the casting film 11 possible. During the formation of the casting film 11, solvent vapors evaporated from the casting film 11 is condensed and liquefied by the condenser 35 and recovered by the recovery device 36 so as to prevent degradation in planarity of the casting film 11 due to adhesion of the solvent vapors to the surface of the casting film 11. The recovered solvent may be recycled as a recycled solvent by connecting a refining device (not shown) to the recovery device 36 and refining the recovered solvent. The recycled solvent is used as the solvent for preparing the dope. Thus, the raw material cost is reduced.

The peel roller 34 peels off the casting film 11 from the casting drum 32 while supporting the casting film 11. It is preferable to peel the casting film 11 when the residual solvent amount is as high as possible. It is preferable to peel the casting film 11 before its residual solvent amount reaches 100 wt. % since the stretching of the casting film 11 in the first tenter which is the subsequent step to the peeling needs to be ended before the residual solvent amount reaches 100 wt. %. On the other hand, in view of self-supporting property of the casting film 11, it is more preferable to peel the casting film 11 after its residual solvent amount reaches 320 wt. % in order that the peeled casting film 11 has sufficient self-supporting property for conveyance. Accordingly, it is more preferable to peel the casting film 11 with the residual solvent amount of not less than 100 wt. % and not more than 320 wt. %. The residual solvent amount of the casting film 11 is a value (dry measure) calculated by a mathematical expression {(x−y)/y}×100, when x represents a weight of a sample taken from the casting film 11, and y represents a weight of the completely dried sample. In the case a plurality of solvents are used, the residual solvent amount is defined as the total of the residual solvent amounts.

The residual solvent amount of the casting film 11 on the casting drum 32 determines the timing of peeling the casting film 11. Methods to measure the residual solvent amount are not particularly limited. For example, a small-scale film production under the same condition with this embodiment may be performed in advance to obtain the data of correlation between the casting time and the residual solvent amount of the casting film 11, and an actual casting time may be determined according to the correlation data. Alternatively, a part of the casting film 11 on the support is taken as a sample and the residual solvent amount may be calculated by the above described method.

The casting film 11 is sent to the transfer section 21 and conveyed therethrough while being supported by the pass rollers 21a. In the transfer section 21, the rotation speed of the pass rollers 21a placed close to the outlet of the transfer section 21 is made faster than that of the pass rollers 21a placed close to the inlet of the transfer section 21, so as to impart tension to the casting film 11 in the conveying direction. Thereby, the casting film 11 is stretched as necessary in the conveying direction. In the transfer section 21, dry air, whose temperature is adjusted to a predetermined value, is supplied from the drying device 40. Thereby, the casting film 11 is uniformly dried while being conveyed through the transfer section 21.

In the present invention, it is preferable to apply the tension to the casting film 11 and stretch the casting film 11 at a stretch ratio of not less than 5% and not more than 35% in the conveying direction when the residual solvent amount of the casting film 11 is not less than 100 wt. % and not more than 320 wt. % and dry the casting film 11 by heating the casting film 11 by the drying device 40 to reach not less than 50° C. and not more than 140° C. To stretch the casting film 11 in the conveying direction is to stretch the casting film 11 in the longitudinal direction. To stretch the casting film 11 at the ratio of not less than 5% and not more than 35% in the conveying direction is to stretch the casting film 11 to satisfy 5≦100×(X2−X1)/X1≦35 when X1 is a distance before the stretching and X2 is a distance after the stretching with respect to a distance between given two points on the casting film 11 in the conveying direction.

In this embodiment, the casting film 11 is stretched and dried by controlling the roller conveying speed of the transfer section 21 and the moving speed of the pin plates in the first tenter 22 so as to satisfy the above conditions. The casting film 11 with a large residual solvent amount has a large free volume so that the casting film 11 is effectively stretched in the conveying direction. Therefore, a degree of orientation of the polymer is increased in the conveying direction using a small amount of thermal energy. When the residual solvent amount of the casting film 11 exceeds 320 wt. %, the casting film 11 becomes extremely unstable which makes it difficult to convey. On the other hand, when the residual solvent amount is less than 100 wt. %, the free volume of the casting film 11 is small so that the thermal energy necessary for stretching increases. The temperature of the dry air is determined in view of kinds of the raw material of the dope, production speed, and the like so as to heat the casting film 11 to not less than 50° C. and not more than 140° C. Stretching methods are not particularly limited. For example, peel stress applied to the casting film 11 at the time of peeling the casting film 11 from the casting drum 32 may be controlled.

The casting film 11 which has been further dried is sent to the first tenter 22. At a predetermined position in the first tenter 22, the both side edge portions of the casting film 11 are pierced and held by the pins. Thereafter, the casting film 11 is conveyed in accordance with the movement of the chains. The first drying device (not shown) supplies the dry air at a predetermined temperature to the inside of the first tenter 22 to control the inner temperature thereof. Thereby, the casting film 11 is dried efficiently and effectively without occurrence of wrinkles and twitches while being conveyed in a state that the both side edge portions are securely held. The dried casting film 11 is sent to the conveying section 37 and is further dried by supplying dry air from the drying device (not shown) while being supported by the rollers 37a. Thereafter, the casting film 11 is sent to the first winding chamber 24 and wound by the winding shaft 23 while being pressed by the press roller 23a. Thus, the casting film 11 is further dried and wound into the roll form.

Next, the casting film 11 is formed into the film 17 in the second film producing apparatus 16. First, the casting film 11 in the roll form is set in the feeding device 42 in the second film producing apparatus 16. Next, the casting film 11 is fed from the feed chamber 41 to the second tenter 43.

In the second tenter 43, the both side edge portions of the casting film 11 are held by clips at a predetermined position in the proximity of the inlet of the second tenter 43. Thereafter, the casting film 11 is conveyed in accordance with the movement of the chains along the rails. The distance between the rails is adjusted to increase from the inlet toward the outlet of the second tenter 43. The inner temperature of the second tenter 43 is adjusted by supplying dry air from the second drying device. Thereby, the casting film 11 is gradually stretched and further dried without the occurrence of wrinkles and twitches while being conveyed through the second tenter 43.

After the residual solvent amount reaches 10 wt. %, the casting film 11 is guided to the second tenter 43. In the second tenter 43, cellulose ester is crystallized and the casting film 11 is stretched in the width direction. Thereby, the following are achieved: (1) an absolute value |P1| of the degree of orientation P1 of the cellulose acylate is reduced to a value of not less than zero and not more than 0.05; and (2) the retardation Re is increased to a large value of at least 40 nm and up to 80 nm. As a result, the produced cellulose ester film has a high retardation value and low humidity dependence of the Re. The intrinsic birefringence of the cellulose ester is changed to negative, and the retardation values in the conveying direction and the width direction are increased. The following describes the crystallization and stretching performed in the second tenter 43.

In the second tenter 43, the casting film 11 is heated to a high temperature in a range in which deterioration of cellulose ester has been concerned. To be more specific, the casting film 11 is heated to a high temperature of not less than 170° C. and not more than 250° C. Thereby, the cellulose ester is crystallized. The crystallization of the cellulose ester is caused by increase in the temperature of the casting film 11. The temperature of the casting film 11 is increased by dry air at an adjusted temperature blown from the second drying device. In other words, by setting the temperature of the dry air at an appropriate value, the temperature of the casting film 11 is increased to a value of not less than 170° C. and not more than 250° C. As a result, the cellulose ester is crystallized.

To crystallize the cellulose ester rapidly within a limited area, that is, in the second tenter 43, the residual solvent amount of the cellulose ester needs to be equal to or less than 10 wt. % (including zero wt. %). In the case the casting film 11 is not wound in the first film producing apparatus 10, for example, the first tenter 22 and the second tenter 43 may be connected to configure a single production line, the casting film 11 may be dried in the transfer section 37 which is between the first and the second tenters 22 and 43 to reduce the residual solvent amount to 10 wt. %. Thus, in the second tenter 43, the residual solvent amount is reduced in a range of zero wt. % to 10 wt. %.

The casting film 11 in which the cellulose ester is crystallized is stretched in the width direction. In this specification, to stretch the casting film in the width direction is to increase the width of the casting film 11. It is preferable that the temperature of the casting film 11 is increased at the time of stretching. In view of energy efficiency in the producing line, it is preferable to stretch the casting film 11 before the temperature which has been raised by crystallization of the cellulose ester decreases and becomes too low. For this reason, it is preferable to perform both crystallization and stretching in the width direction in the second tenter 22 as described in this embodiment. The stretching may be started after the start of crystallization, and continued while the crystallization is advanced.

At the time of stretching the casting film 11 in the width direction, it is preferable that the temperature of the casting film 11 is not less than 170° C. and 250° C. Although the casting film 11 has a small amount of the residual solvent amount and small free volume, the casting film 11 is softened by heating to the above temperature and efficiently stretched in the width direction. In the case the casting film 11 is stretched in the width direction at a temperature of less than 170° C., it may become difficult to change intrinsic birefringence of cellulose ester. On the other hand, when the temperature of the casting film 11 exceeds 250° C., it is concerned that the second film producing apparatus 16 may be contaminated due to the solvent vapors evaporated from the casting film 11.

It is preferable to stretch the casting film 11 in the width direction with a stretch ratio not less than 10% and not more than 60%. In the case the stretch ratio is less than 10%, the effect of increasing the degree of orientation in main chains of the cellulose ester may not appear. On the other hand, in the case the stretch ratio exceeds 60%, the casting film 11 may be torn by holding sections such as clips. The stretch ratio is relative to the width of the casting film 11 upon entrance to the second tenter 43. To be more specific, the stretch ratio (unit: %) is calculated by 100×D2/D1 when D1 is the width at the start T1 of the stretch, and D2 is the width at the end T2 of the stretch, and the width is stretched from D1 to D2.

The casting film 11 may be stretched in the width direction continuously or intermittently, while or after the cellulose ester is crystallized. In the intermittent stretching, for example, the casting film 11 is stretched in the width direction for the first time, and the stretched width is kept, and then the casting film 11 is stretched in the width direction for the second time. In the case the casting film 11 is intermittently stretched, D1 is defined as the width of the casting film 11 at the start of the first stretching, and D2 is defined as the width of the casting film 11 at the end of the last stretching. In the above example, D1 is defined as the width of the casting film 11 at the start of the first stretching, and D2 is defined as the width of the casting film 11 at the end of the second stretching.

The degree of orientation in the width direction of the cellulose ester is increased by stretching the width of the casting film 11 in the width direction according to the above conditions. As the degree of orientation increases, a difference between the degree of orientation in the conveying direction and that in the width direction approaches zero. As a result, the film 17 having high retardation value and low humidity dependence of the Re is produced. When the casting film 11 is conveyed close to the outlet of the second tenter 43, the both side edge portions of the casting film 11 are released from the clips. The film 17 discharged from the second tenter 43 is sent to the edge slitting device 45 and the both side edge portions of the film 17 are cut off. Thereby, damaged portions with holes made by the pins and scratches caused by clips are removed from the film 17. Thus, the film 17 with the excellent planarity is produced. The process to cut off the both side edge portions of the film 17 may be omitted. However, this process is preferably performed in the process after the first tenter 22 and before forming the end product. The number of times to cut off the both side edges of the film 17 and the number of the edge slitting devices 45 are not particularly limited. For example, the edge slitting device 45 may be installed at the downstream from the first tenter 22 so as to cut the both side edge portions of the casting film 11 before winding.

The film 17 is sent to the drying chamber 46. The inner temperature of the drying chamber 46 is adjusted using the temperature controller 60. While being bridged across the rollers 58 and conveyed, the film 17 is dried and the residual strain thereof is reduced. The residual strain is caused by the stretching of the casting film 11 in the second tenter 43. The inner temperature of the drying chamber 46 is not particularly limited. However, it is preferable to adjust the surface temperature of the film 17 to be not less than 60° C. and not more than 145° C. so as to effectively evaporate the solvent without damaging the polymer in the film 17 by heat, and effectively reduce the residual strain. The film surface temperature is measured by placing a thermometer at a position right above the conveying path of the film 17, close to the surface of the film 17.

In this embodiment, the adsorption-recovery device 59 is connected to the drying chamber 46 to recover the solvent vapors (solvent gas) evaporated from the film 17 at the time of drying. The recovered gas is supplied to the drying chamber 46 as dry air after the solvent components of the recovered solvent gas are removed. Thus, energy cost is reduced, resulting in reduction of the production cost. In addition, it is preferable to provide a pre-drying chamber (not shown) between the edge slitting device 45 and the drying chamber 46 to pre-dry the film 17. Thereby, changes in shapes and conditions of the film 17 caused by abrupt increase of the film surface temperature is prevented in the drying chamber 46.

The sufficiently dried film 17 is sent to the cooling chamber 48. In the cooling chamber 48, the film 17 is gradually cooled to the room temperature without occurrence of wrinkles and twitches caused by abrupt temperature changes. Methods to cool the film 17 are not particularly limited. For example, the film 17 may be cooled by natural cooling or with the use of a temperature controller (not shown) in the cooling chamber 48. It is preferable to provide a moisture control chamber (not shown) between the drying chamber 46 and the cooling chamber 48 so as to feed the film 17 to the cooling chamber 48 after its moisture content is controlled. Even if there are wrinkles and the like on the surface of the film 17, such wrinkles are effectively smoothed.

The film 17 which reached the room temperature is sent to the neutralization device 50, and the charged voltage of the film 17 is adjusted to be in a predetermined range (for example, −3 kV to +3 kV). FIG. 1B shows a configuration in which the neutralization device 50 is installed at the downstream from the cooling chamber 48. However, the installation position and the number of the neutralization device 50 are not particularly limited. The pair of knurling rollers 51 provides knurling by embossing the both side edge portions of the film 17.

Lastly, the film 17 is sent to the second winding chamber 54, and wound by the winding shaft 62 while the tension of winding is adjusted by the press roller 65. It is preferable to gradually change the tension of winding from the start to the end of winding. It is preferable that the width of the film 17 is 1400 mm to 2300 mm. However, the present invention is also applicable to films 17 having the width larger than 2300 mm. In addition, it is preferable that the thickness of the film 17 is 20 μm to 150 μm. It is more preferable that the thickness of the film 17 is 25 μm to 100 μm. It is especially preferable that the thickness of the film 17 is 40 μm to 90 μm.

As described above, the casting film 11 is produced from the dope containing the retardation controller, cellulose ester, and the solvent, and the stretch ratio of the casting film 11 is adjusted by controlling the tension in the conveying direction or the width direction in accordance with the residual solvent amount of the casting film 11. Thus, the stretch ratio of the casting film 11 is appropriately adjusted in accordance with the difference in the free volume. Thereby, the degrees of orientation of cellulose ester are efficiently increased in the conveying direction and width direction, and the difference between the degrees of orientation in the conveying direction and the width direction approaches zero. The degree of orientation P1 of cellulose ester in the in-plane direction of the cellulose ester film satisfies 0≦|P1|≦0.050. Thus, the film whose degree of orientation P1 of cellulose acylate is made as close to zero as possible and which optimized the degree of orientation of the retardation controller has low humidity dependence. As a result, changes in the retardation Re are prevented. The in-plane retardation Re represented by the mathematical expression (1) is not less than 40 nm and not more than 80 nm. Thus, the cellulose ester film has the in-plane retardation Re of at least 40 nm and up to 80 nm, and achieves the low humidity dependence of the Re and the high retardation at the same time. The retardation Re is a value when the conveying direction of the casting film is considered as the negative direction. It is preferable when P1 satisfies 0≦|P1|≦0.025. It is especially preferable when P1 satisfies 0≦|P1|≦0.010. When the absolute value |P1| of the degree of orientation P1 exceeds 0.050, the degree of orientation of the polymer is increased and humidity dependence of the retardation Re is increased.

The retardation “Rth” in the thickness direction of the cellulose ester film is not less than 100 nm and not more than 300 nm. The retardation Rth is represented by the mathematical expression (2) which will be described later. Thus, the Re and the Rth of the cellulose ester film are controlled so that the cellulose ester film has contrast capable of achieving excellent display quality. The contrast is improved as the Re and the Rth are increased. Accordingly, viewing angle dependence which causes a displayed image to appear in different colors and brightness when viewed from different angles is reduced. However, if the Re and the Rth do not satisfy the above conditions, a quality required for the retardation film cannot be satisfied. The Re and the Rth are easily obtained by measuring nx, ny, and nz at the wavelength of λ using an automatic birefringence analyzer (for example, model name: KOBRA21DH produced by Oji Scientific Instruments), and substituting the measured values into mathematical expressions (1) and (2).

As well known, the produced film 17 was used as a sample, and the degree of orientation P1 of the polymer in the in-plane direction was measured by X-ray diffraction. An X-ray diffractometer was used to perform an in-plane analysis of a thin film. The sample was tilted at an angle between 2θχ (χ is “chi”) and φ, and the peak intensity 2θχ/φ=6° to 11° was detected. |P1| is calculated using the following mathematical expressions (3) and (4). The mathematical expression (3) is known as a general expression for the degree of orientation in the in-plane direction.

P1=(3 cos β²−1)/2 (3)

cos²β=∫₀^{π} cos²β·I(β)·sin βdβ/∫₀^{π}I(β)·sin βdβ (4)

Humidity dependence may be evaluated by water vapor transmission, water absorption ratio, or coefficient of water-absorption expansion. The water vapor transmission is an index to evaluate transmission of water vapor through the cellulose ester film, and measured according to methods disclosed in JIS Z 0208. The water vapor transmission is defined as water content (unit: g) evaporated from 1 m² of cellulose ester film in 24 hours. The water vapor transmission increases as the above water content increases, in other words, humidity dependence increases. Therefore, it is preferable to lower the water vapor transmission as much as possible.

Water absorption ratio is a ratio of water absorbed in cellulose ester film. The water absorption ratio is evaluated by measuring an equilibrium water content under predetermined temperature and humidity conditions. The equilibrium water content in the film formed of cellulose acylate is not more than 5 wt. %, and more preferably not more than 3 wt. % under 25° C./80% RH. It is preferable to reduce the equilibrium water content as much as possible to reduce the humidity dependence. To obtain the equilibrium water content, for example, a water content of a sample film which reached equilibrium is measured by Karl Fischer Method after the sample film is left for 24 hours under 25° C./80% RH, and the water content (unit: g) is divided by the sample weight (unit: g).

Coefficient of water-absorption expansion is defined as an amount of a change in a length of a sample film when relative humidity is changed under the same temperature. In the case the cellulose acylate is used, the coefficient of water-absorption expansion of the film is preferably not more than 30×10⁻⁵/% RH under relative humidity RH, and more preferably not more than 15×10⁻⁵/% RH. It is especially preferable that the coefficient of water-absorption expansion is not more than 10×10⁻⁵/% RH. It is preferable to lower the coefficient of water-absorption expansion as much as possible. However, the coefficient of the water-absorption expansion normally takes a value of not less than 1×10⁻⁵/% RH. To measure the coefficient of water-absorption expansion, the following measuring method may be used as an example. A sample film of 5 mm by 20 mm is cut out from the produced film. In an atmosphere of 25° C./20% RH(R0), the sample film is hung down with its one end fixed. A weight of 0.5 g is applied to the other end of the sample film. 10 minutes later, a length L0 of the sample film is measured. Next, a length L1 of the sample film is measured while the temperature is kept at 25° C. but humidity is changed to 80% RH (R1). The coefficient of water-absorption expansion [/% RH] is calculated from the following mathematical expression (5):

[/% RH]={(L1−L0)/L0}/(R1−R0) (5)

In this embodiment, the first film producing apparatus 10 and the second film producing apparatus 16 are used, and an off-line configuration in which the production line is temporarily suspended is shown. However, the crystallization and the stretching in the width direction may not necessarily be performed in the off-line. For example, the crystallization and the stretching in the width direction may be continuously performed in the second tenter 43 on-line by connecting the second tenter 43 to the downstream of the first tenter 22 through the transfer section 37.

The present invention exhibits excellent effects regardless of the layer structure of the film. In other words, the present invention is suitable as a method to produce a single layer film from one kind of dope or a multilayer film from plural kinds of dopes. Methods of producing the multilayer film are not particularly limited. For example, the multilayer film may be produced by co-casting in which plural dopes are simultaneously cast or sequential casting using plural casting dies. It is also possible to combine the co-casting method and the sequential casting method.

Casting dies, decompression chambers, structures of supports, co-casting, peeling methods, stretching, drying conditions of each process, handling methods, curls, winding methods after planarity of films is improved, solvent recovery methods, and film recycling methods are disclosed in paragraphs [0617] and [0889] in Japanese Patent Laid-Open Publication No. 2005-104148.

Properties of the produced cellulose ester film, degrees of curling, the thickness, and measuring methods thereof are disclosed in paragraphs [1073] and [1087] of Japanese Patent Laid-Open Publication No. 2005-104148.

When the produced cellulose ester film is used as an optical film, it is preferable to perform surface treatment to at least one of the film surfaces so as to improve adhesion property to other optical parts. It is preferable to perform at least one of the following treatments as the surface treatment: for example, vacuum glow discharge, plasma discharge under the atmospheric pressure, UV-ray irradiation, corona discharge, flame treatment, acid treatment and alkali treatment.

The produced cellulose ester film may be used as a base film for a functional film by providing a functional layer to at least one of the surfaces. Examples of the functional layer are an antistatic layer, a curable resin layer, an anti-reflection layer, an easy-adhesion layer, an anti-glare layer, optical compensation layer and the like. It is preferable to provide at least one of the above layers. For example, an anti-reflection film, which is a functional film imparting an anti-reflection effect to LCD devices, may be produced by providing an anti-reflection layer to the cellulose ester film. It is preferable that the above functional layer includes at least one kind of additives such as surfactants, lubricants, matting agents, and antistatic agents. An amount of such additive may be preferably 0.1 to 1000 mg/m². Functional layers for imparting various functions to the film and forming methods thereof are detailed in paragraphs [0890] to [1072] of Japanese Patent Laid-Open Publication No. 2005-104148, which may be applied to the present invention.

The cellulose ester film produced in the present invention has high optical transparency, high retardation value, and low humidity dependence. For this reason, the cellulose ester film is preferably used as a retardation film of a polarizing filter. However, the uses of the cellulose ester film are not particularly limited. For example, the cellulose ester film may be used as a protection film for a polarizing filter to protect the surface of the polarizing filter. The cellulose ester film of the present invention may be used in, for example, a TN type, a STN type, a VA type, an OCB type, a reflection type, and other types of LCDs, and such applications are detailed in, for example, paragraphs [1088] and [1265] of Japanese Patent Laid-Open Publication No. 2005-104148. These descriptions may be applied to the present invention.

Hereinafter, examples and comparative examples according to the present invention are described. However, these examples and comparative examples do not limit the scope of the present invention.

### EXAMPLE 1

A dope was prepared by mixing the following raw materials of the dope. The amount of the retardation controller was 4.0 wt. % relative to the weight of cellulose acetate of the produced film. Cellulose triacetate powder described below was used: degree of substitution was 2.84, viscometric average degree of polymerization was 306, water content was 0.2 wt. %, viscosity of 6 wt. % of dichloromethane solution was 315 mPa·s, average particle diameter was 1.5 mm, and standard deviation of the particle diameter was 0.5 mm. The plasticizer “A” was triphenylphosphate. The plasticizer “B” was diphenyl phosphate. The UV agent “a” was 2-(2′-hydroxy-3′,5′-di-tert-butylphenyl) benzotriazol and UV agent “b” was 2-(2′-hydroxyl-3′,5′-di-tert-amylphenyl)-5-chlorobenzotriazol. The citric acid ester mixture was a mixture of citric acid, citric acid monoethyl ester, citric acid diethyl ester and citric acid triethyl ester. Fine particles were silicon dioxide with average particle diameter of 15 nm and Mohs hardness of approximately 7.

### [Raw Material of Dope]

| | | |
|---|---|---|
| Cellulose triacetate | 100 | pts. wt. |
| Dichloromethane | 320 | pts. wt. |
| Methanol | 83 | pts. wt. |
| 1-Butanol | 3 | pts. wt. |
| Plasticizer A | 7.6 | pts. wt. |
| Plasticizer B | 3.8 | pts. wt. |
| UV agent a: | 0.7 | pts. wt. |
| UV agent b: | 0.3 | pts. wt. |
| Citric acid ester mixture | 0.006 | pts. wt. |
| Fine particles | 0.05 | pts. wt. |
| Retardation controller | | |
| (N-N′-di-m-tolyl-N″-P-methoxyphenyl-1,3,5-triazine- | 4.0 | pts. wt. |
| 2,4,6-triamine) | | |

### [Production of the Film]

An appropriate amount of the dope was fed from the dope producing apparatus 26 to the feed block 30 through the pipe 25. Then, the dope was fed to the casting die 31. The casting die 31 installed in the casting chamber 20 had a slit having a width of 1.8 m as a discharge opening of the dope and a jacket (not shown) capable of adjusting the inner temperature of the casting die 31. The casting drum 32 was made of SUS 316 and the number of rotation was controlled by a driving device (not shown). The casting drum 32 was placed immediately below the discharge opening of the casting die 31. The rotation speed of the casting drum 32 was set at 100 m/min. The inner temperature of the casting chamber 20 was maintained at 35° C. by the temperature controller 38.

The dope was discharged through the discharge opening of the casting die 31 onto the casting drum 32 while the discharge amount of the dope was adjusted to produce the film 17 with the thickness of 80 μm. The surface temperature of the casting die 31 was adjusted at −5° C. The inner temperature of the casting die 31 was adjusted by feeding the heat transfer medium whose temperature was controlled at a predetermined value inside the jacket. The inner temperature of the casting die 31 was adjusted to keep the temperature of the dope at 36° C. The inner temperature of the feed block 30, the pipe, and the like were also kept at 36° C. using devices having temperature adjusting functions.

The dope was cooled on the casting drum 32 and gelated. Thereby, the casting film 11 in the gel state was formed. The gelation of the casting film 11 was enhanced until the casting film 11 obtains the self-supporting property. Thereafter, the casting film 11 was peeled off from the casting drum 32 by applying tension in the conveying direction while being supported by the peel roller 34. The residual solvent amount of the casting film 11 at the time of peeling was 280 wt. %. Next, the casting film 11 was sent to the transfer section 21. While being supported and conveyed by the pass rollers 21a, the casting film 11 was further dried by dry air supplied from the drying device 40. The temperature of the dry air was adjusted at 40° C. Thereafter, the casting film 11 was sent to the first tenter 22 which was a pin tenter. While the casting film 11 was conveyed with the both side edge portions of the casting film 11 pierced by pins, the casting film 11 was further dried until the residual solvent amount reaches 1 wt. %. After being supported by the rollers 37a and conveyed to the first winding chamber 24, the casting film 11 was wound by the winding shaft 23 in a roll form. The casting film 11 was stretched at a stretch ratio of 15% in the conveying direction by adjusting the peel tension and a rotation speed of the pass rollers 21a in the transfer section 21.

The casting film 11 is sent from the feeding device 42 to the second tenter 43. A clip-tenter was used as the second tenter 43. The second tenter 43 had a plurality of clips and was provided with endless chains which moved continuously in accordance with the rails. The distance between the rails was adjusted such that the distance gradually increased from the inlet toward the outlet of the second tenter 43. The both side edge portions of the casting film 11 were held by the clips at the predetermined position in the second tenter 43. Thereafter, the casting film 11 was stretched in the width direction during the conveyance inside the second tenter 43 in accordance with the movement of the chains. In the second tenter 43, in order to crystallize the cellulose ester by keeping the temperature of the casting film 11 at 220° C., dry air at the same temperature as the casting film 11 is supplied from the second drying device (not shown). During the crystallization, the casting film 11 is stretched in the width direction and the drying of the casting film 11 is advanced. Thus, the film 17 is produced. The stretch ratio of the casting film 11 in the second tenter 43 is shown in Table 1.

The edge slitting device 45 having the NT cutter was provided at a position where the film 17 reached within 30 seconds after the film 17 was discharged from the outlet of the second tenter 43. The both side edge portions of the film 17 were cut off along lines 50 mm inside the side edges of the film 17. The cut side edge portions of the film 17 were sent to the crusher 56 using the cutter blower (not shown) and crushed into chips of approximately 80 mm².

In this embodiment, a pre-drying chamber (not shown) was provided between the edge slitting device 45 and the drying chamber 46. In the pre-drying chamber, dry air was supplied at 100° C. to preheat the film 17 before the film 17 is dried in the drying chamber 46 at a high temperature. Next, the film 17 was sent to the drying chamber 46. While being bridged across the rollers 58 and conveyed, the film 17 was dried for about 10 minutes. The surface temperature of the film 17 was adjusted at 140° C. by supplying dry air at a temperature of a properly adjusted value from the temperature controller 60 to the drying chamber 46. The film surface temperature was measured by placing a thermometer at a position right above the conveying path of the film 17, close to the surface of the film 17. In the drying chamber 46, the solvent vapors were recovered by the adsorption-recovery device 59. In the adsorption-recovery device 59, an adsorbent was activated carbon, and a desorbent was dry nitrogen. The recovered solvent was treated such that water content was reduced to not more than 0.3 wt. %.

A moisture control chamber (not shown) was provided between the drying chamber 46 and the cooling chamber 48. In the moisture control chamber, air (dew point: 20° C.) and the temperature of 50° C. was supplied to the film 17. Subsequently, air at the temperature of 90° C. with the humidity of 70% was directly blown onto the film 17 to control the moisture of the film 17 so as to smooth out curls. Then, the film 17 was sent to the cooling chamber 48 and gradually cooled until the film 17 reached 30° C. The charged voltage of the film 17 was adjusted in a range of −3 kV to +3 kV by the neutralization device 50. Knurling was provided, by the pair of knurling rollers 51, to both side edge portions of the film 17 so as to make projections and depressions of the film 17 uniform. The width of the knurling was 10 mm. The embossing was performed from one side of the film 17 while pressure of the pair of knurling rollers was adjusted such that the average thickness of the film 17 after the knurling becomes 12 μm larger than that before the knurling.

Lastly, the film 17 was wound by the winding shaft 62 (diameter: 169 mm) set inside the second winding chamber 54. The tension at the start of the winding was adjusted to be 300 N/m. The tension at the end of the winding was adjusted to be 200 N/m. The film 17 was wound while being pressed by the press roller 65 with the pressure of 50 N/m. Thereby, the film 17 with the film thickness of 80 μm was produced.

The produced film 17 was used as a sample, and the absolute value of the degree of orientation |P1| of the polymer in the in-plane direction was measured by X-ray diffraction. The P1 and the |P1| are shown in the Table 1. The measured value was 0.030. An X-ray diffractometer (RINT RAPID, produced by Rigaku Corporation) was used to perform an in-plane analysis of a thin film. The sample was tilted at an angle between 2θχ and φ, and the peak intensity 2θχ/=φ6° to 11° was detected. |P1| is calculated using mathematical expressions (3) and (4).

### [EXAMPLE 2] TO [EXAMPLE 5], AND [COMPARATIVE EXAMPLE 1] TO [COMPARATIVE EXAMPLE 7]

The temperatures and the stretch ratios of the casting film 11 in the second tenter 43 are shown in the Table 1. Other conditions are the same as in the example 1. In the comparative examples 1 and 2, the stretching of the film in the width direction was performed in the first tenter 22, but not in the second tenter 43. The stretch ratio of the film in the first tenter 22 is shown in the third column of “stretch ratio of the casting film 11 in the width direction” in the Table 1.

The following optical properties of each film produced in the examples 1 to 5 and the comparative examples 1 to 7 are measured and evaluated: (1) The in-plane retardation Re and the retardation Rth in the thickness direction; and (2) humidity dependence. The measuring method and the evaluation method are described below.

[Measurement of Retardation Values Re and Rth]

Moisture of a sample cut out in the size of 70 mm×100 mm from each of the produced films 17 was controlled under 25° C. and 60% RH for two hours. Thereafter, the reflective indices of the sample in the in-plane direction and the thickness direction were measured at a wavelength (λ) of 632.8 nm using an automatic birefringence analyzer (model name: KOBRA21DH, produced by Oji Scientific instruments). The measured values were put in the mathematical expressions (1) and (2), and the retardation values Re and Rth were calculated. “nx” is a refractive index in the slow axis direction in the in-plane of the film 17. “ny” is a refractive index in the fast axis direction in the in-plane of the film 17. “nz” is a refractive index in the thickness direction of the film 17. The slow axis direction was parallel to the conveying direction. The fast axis direction was parallel to the width direction.

[Humidity Dependence]

The in-plane retardation values Re1 and Re2 of each of the above samples were measured. The Re1 was the value obtained after the film 17 was left under 25° C. and 10% RH for 2 hours, and the Re2 was the value obtained after the film 17 was left under 25° C. and 80% RH for 2 hours. Thereafter, a difference |Re1−Re2| was calculated, and humidity dependence was evaluated using the calculated value. The films 17 with smaller |Re1−Re2| values are less humidity dependent, and more suitable as the optical films.

Evaluation results of the examples 1 to 3 and comparative examples 1 and 2 are shown in the Table 1 below. “E1” to “E5” denote examples 1 to 5. “C1” to “C7” denote comparative examples 1 to 7. The number on the top of each column indicates the following.

1: whether the retardation controller was used or not.

Y: the retardation controller was used.

N: the retardation controller was not used.

2: temperature of the casting film 11 in the second tenter 43 (unit: ° C.).
3: stretch ratio of the casting film 11 in the width direction; stretch ratios in the first tenter 22 in the comparative examples 1 and 2, and stretch ratios in the second tenter 43 in the examples 1 to 5 and the comparative examples 3 to 7 (unit: %).
4: degrees of orientation of cellulose ester P1
5: absolute values of the degrees of orientation of cellulose ester |P1|

### 6: |Re1−Re2|

7: in-plane retardation Re (unit: nm)
8: evaluation of the Re

A: Re is 50 nm or more (very preferable)

B: Re is equal to or more than 40 nm and less than 50 nm (preferable)

F: Re is less than 40 nm (not preferable)

9: retardation Rth in the thickness direction (unit: nm)
10: evaluation of the Rth

A: Rth is equal to or more than 100 nm and not more than 300 nm (preferable)

F: Rth is less than 100 nm (not preferable)

In the comparative examples 1 and 2, the stretching was performed in the first tenter 22, but the crystallization was not performed in the second tenter 43. To be more specific, the casting film 11 was heated to a temperature of not more than 170° C. and stretched in the first tenter 22. Accordingly, “-” is indicated in the column 2 of the comparative examples 1 and 2, showing that the casting film 11 is not heated to a temperature in a range of 170° C. to 250° C. in the second tenter 43. In the comparative examples 1 and 2, the stretch ratios in the width direction (the column 3) are 15% and 50% respectively. In the comparative example 4, the casting film 11 is decomposed by heat in the second tenter 43. Accordingly, measurements were not performed, and “-” is indicated in each of the columns 4 to 10.

TABLE 1

| | | | | | | | 7 | | 9 | |
|---|---|---|---|---|---|---|---|---|---|---|
| | 1 | 2 | 3 | 4 | 5 | 6 | (nm) | 8 | (nm) | 10 |
| E1 | Y | 220 | 40 | 0.003 | 0.003 | 2 | 58 | A | 200 | A |
| E2 | Y | 170 | 40 | 0.003 | 0.003 | 2 | 55 | A | 190 | A |
| E3 | Y | 250 | 40 | 0.003 | 0.003 | 2 | 60 | A | 220 | A |
| E4 | Y | 220 | 10 | −0.040 | 0.040 | 4 | 51 | A | 190 | A |
| E5 | Y | 220 | 60 | 0.040 | 0.040 | 4 | 80 | A | 300 | A |
| C1 | Y | — | 15 | 0.003 | 0.003 | 2 | 10 | F | 200 | A |
| C2 | Y | — | 50 | 0.070 | 0.070 | 8 | 55 | A | 200 | A |
| C3 | Y | 160 | 40 | 0.003 | 0.003 | 2 | 35 | F | 150 | A |
| C4 | Y | 270 | 40 | — | — | — | — | — | — | — |
| C5 | Y | 220 | 5 | −0.060 | 0.060 | 6 | 50 | A | 187 | A |
| C6 | Y | 220 | 65 | 0.060 | 0.060 | 6 | 83 | A | 310 | A |
| C7 | N | 220 | 40 | 0.003 | 0.003 | 2 | 30 | F | 80 | F |

As described above, according to the present invention, the degrees of molecular orientation of the cellulose ester and the retardation controller are efficiently and effectively controlled, and the absolute value |P1| of the degree of the orientation P1 of the cellulose ester in the in-plane direction is appropriately adjusted. When |P1| of the film 17 satisfies 0≦P1≦0.050, the retardation values Re and Rth in the in-plane direction and the thickness direction exhibit high values (Re: at least 40 nm and up to 80 nm and Rth: at least 100 nm and up to 220 nm), and molecular density and the degree of orientation of cellulose ester are reduced. Accordingly, humidity dependence of the film is reduced. As a result, the cellulose ester film according to the present invention exhibits excellent display quality.

Although the present invention has been fully described by the way of the preferred embodiments thereof with reference to the accompanying drawings, various changes and modifications will be apparent to those having skill in this field. Therefore, unless otherwise these changes and modifications depart from the scope of the present invention, they should be construed as included therein.

What is claimed is:

1. A cellulose ester film comprising:
a retardation controller;
cellulose ester with a degree of orientation P1 in an in-plane direction of said cellulose ester film satisfying 0≦|P1|≦0.050, and
an in-plane retardation Re of said cellulose ester film of not less than 40 nm and not more than 80 nm, said retardation Re being defined by the following mathematical expression (1):
Re=(nx−ny)×d (1)
wherein nx is a refractive index in a slow axis direction in an in-plane of said cellulose ester film, ny is a refractive index in a fast axis direction in said in-plane, and d is a thickness (unit: nm) of said cellulose ester film.

2. The cellulose ester film of claim 1, wherein a retardation Rth in a thickness direction of said cellulose ester film is not less than 100 nm and not more than 300 nm, and said retardation Rth is defined by the following mathematical expression (2):
Rth={(nx+ny)/2−nz}×d (2)
wherein nx is a refractive index in a slow axis direction in said in-plane, ny is a refractive index in a fast axis direction in said in-plane, and d is a thickness (unit: nm) of said cellulose ester film.

3. A production method of cellulose ester film comprising the steps of:
(a) preparing a dope containing a retardation controller, cellulose ester, and a solvent;
(b) forming a casting film by casting said dope on a cooled moving support;
(c) peeling said casting film from said support and drying said peeled casting film; and
(d) heating said casting film to not less than 170° C. and not more than 250° C. after a residual solvent amount of said casting film reaching 10 wt. % so as to crystallize said cellulose ester, and stretching said casting film containing crystallized cellulose ester at a stretch ratio of not less than 10% and not more than 60% in a width direction.
